(19) United States
(12) Patent Application Publication
(10) Pub. No.: US 2002/0178641 A1
(43) Pub. Date: Dec. 5, 2002

(54) Underwater fishing light and navigational aid

(76) Inventor: Peter James Kent, Sugar Land, TX (US)

Correspondence Address: Philip J. Lee, Suite 525, 10050 Regency Circle, Omaha, NE, 68114-5705, US

(21) Appl. No.: 10/154,653

(22) Filed: May 24, 2002

Related U.S. Application Data
(60) Provisional application No. 60/294,139, filed on May 29, 2001.

(51) Int. Cl. A01K 75/02; A01K 85/00

(52) U.S. Cl. 43/17.5

(57) ABSTRACT

A device for attracting fish comprises an underwater electrically powered light with photoelectric means for activating the light at dusk and deactivating the light at dawn, and weighted to negative buoyancy, the light being connected to an external ballast box in which the lamp ballast, photoelectric switch, and ground fault circuit interrupter are contained and connected to ordinary household current.

### CROSS REFERENCE TO RELATED PROVISIONAL APPLICATION

This application claims the benefit of U.S. Provisional Application No. 60/294,139, filed May 29, 2001.

### BACKGROUND OF THE INVENTION

A. Field of Invention

The present invention relates generally to devices used to attract fish and devices used as aids to navigation, and more particularly to devices, which can usefully perform both functions.

B. Description of Related Art

A variety of fish attractant devices have been proposed, including the use of submersible light emitting devices such as the floating fishing light shown in U.S. Pat. No. 5,194,414 to Downs, the lighted bait bucket described in U.S. Pat. No. 5,133,145 to McDonald, and the submerged light shown in U.S. Pat. No. 4,190,976 to Hurt. Such devices are generally portable and are designed to be deployed from a small boat. Such devices are by nature impermanent and intended to be used in the submerged state for not limited time. Being normally battery operated, such devices cannot be used for long periods in one location without removal.

It has been found advantageous to provide a permanent submerged light for use at locations convenient to shore homes or docks to attract fish and aid in navigation, despite the difficulties inherent in operating an electrically powered light underwater for extended periods.

### SUMMARY OF TH INVENTION

The invention herein described is a 110-volt, high intensity discharge, underwater light intended for permanent or portable installation in three to fifteen feet of water. It is intended uses are attracting fish for night fishing, lighting up shallow water areas for nighttime boat navigation and improving visual appeal of dock areas at night by submerged illumination of the water. The light is turned on and off every night with a photoelectric eye stitch. The unit is protected with an internal ground fault circuit interrupter breaker (G.F.C.I.).

The device is made up of two major elements. The first element is a ballast box mounted near and plugged into a standard 110-volt electrical outlet at or near the desired location of the light. The ballast box is mounted on a fixed structure and is plugged into a household circuit outlet. It is designed to turn the underwater light on at sunset, and off at sunrise, through the use of a photoelectric cell. A weatherproof electrical junction box contains the ballast for a 175-watt mercury vapor lamp, a photoelectric switch, a G.F.C.I. breaker, and a female duplex electrical outlet, into which a power output cord can be plugged. The second major element is a light member made of a 4-inch diameter piece of PVC pipe filled with cement at one end and having a fixture for a 175-watt mercury vapor lamp at the other end. A combination of wax, plastic resin and glue seal the lamp and the lamp fixture from water. The cement weighs the light member down so it stays on the sea floor. The lamp bulb protrudes from the top of the PVC pipe so that it is exposed to the water when submerged. The cement at the bottom of the pipe and the lighter lamp bulb on top makes the light member self righting such that the light member tends to return to a position in which the lamp is higher than the weighted bottom section The light member is intended to rest on the seafloor in two to 12 feet of water and is anchored by the weight of cement inside the light member. The light member may include a 6 inch piece of ½″ PVC pipe that protrudes from the bottom of the light member to penetrate the seafloor and stabilize the position of the light member when deployed. The light member has an electric cord that has a male plug, which plugs into the electrical outlet in the ballast box. All or a portion of the electric cord from the light member runs through a length of protective rubber hose.

This light is intended for use underwater along side commercial and private docks in fresh and saltwater. The intent of the device is to illuminate the water in the immediate vicinity of the light for aesthetic value and to view the fish in the area surrounding the light member. The light member operates on 110/120-volt a/c electricity, frequently from a household circuit.

The principal aim of the present invention is to provide a new and improved submerged electric light which meets the foregoing requirements and which is economical to manufacture from commonly available components and is easy to install and maintain.

Other objects and advantages of the invention will become apparent from the Description of the Preferred Embodiments and the Drawings and will be in part pointed out in more detail hereinafter. The invention consists in the features of construction, combination of elements and arrangement of parts exemplified in the construction hereinafter described and the scope of the invention will be indicated in the appended claims.

### BRIEF DESCRIPTION OF THE DRAWINGS

FIG. 1 is a side view of a preferred embodiment of a device constructed in accordance with the present invention showing the device as installed.

FIG. 2 is a longitudinal section view of a light member of a preferred embodiment of a device constructed in accordance with the present invention.

FIG. 3 is a side view of a light member of a preferred embodiment of a device constructed in accordance with the present invention.

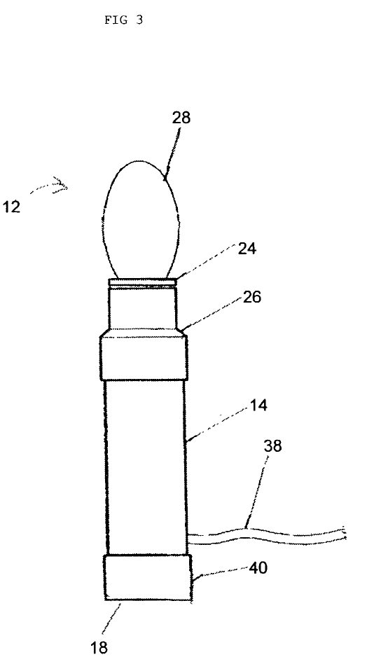

FIG. 4 is a top view of a preferred embodiment of a ballast box for a device constructed in accordance with the present invention, with the cover plate removed.

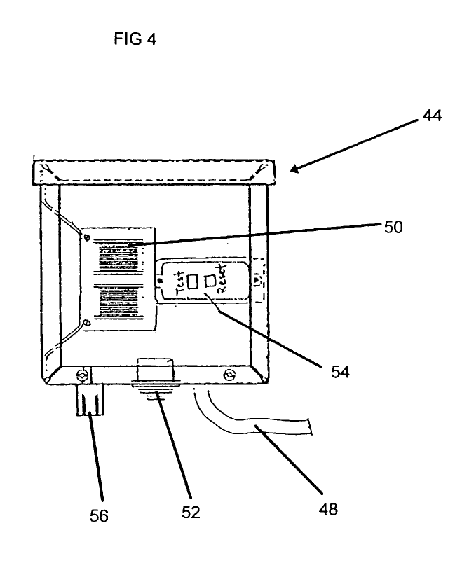

### DESCRIPTION OF THE PREFERRED EMBODIMENT

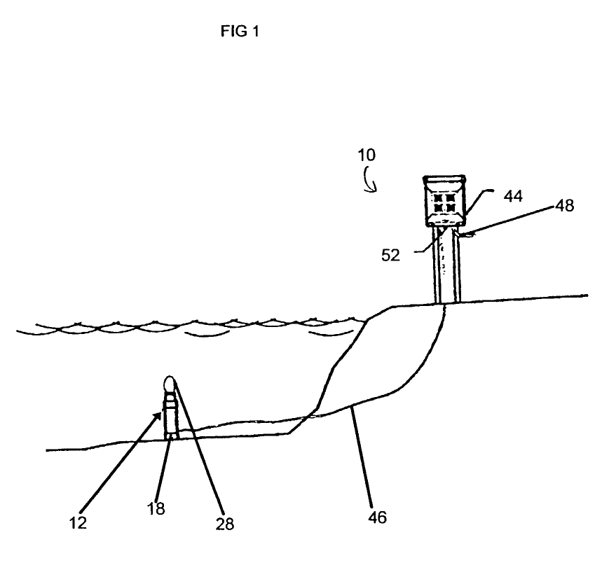

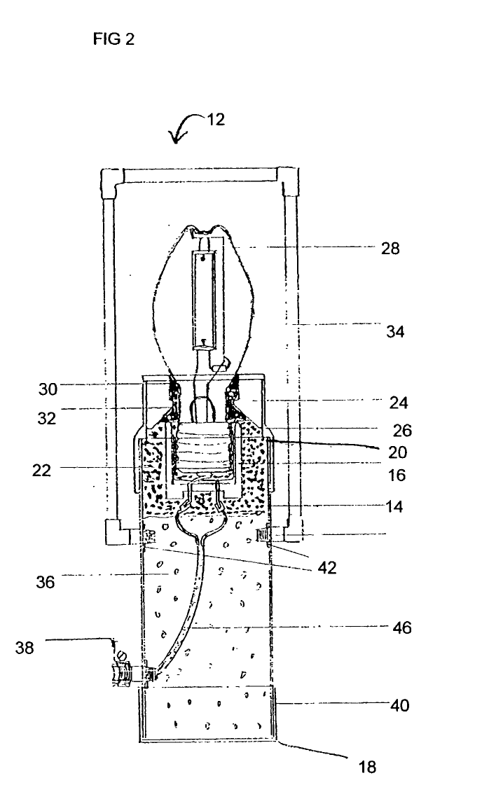

With reference to the Drawings wherein like numerals represent like parts throughout the Figures, an underwater light system in accordance with the present invention is generally designated in FIG. 1 by the numeral 10. The entire underwater lighting system comprises two main parts, light member 12 and a ballast box 44 as shown in FIG. 2, and electrical cord 46 connecting light member 12 and ballast box 44. Ballast box 44 is mounted near and plugged into a standard 110-volt electrical outlet (not shown) by means of a three wire power cord 48. The ballast box 44 is weatherproof and encloses a ballast component 50 comprising such electrical current transformer and components as are necessary for operating a 175-watt mercury vapor lamp, a photoelectric switch 52, a ground fault interrupter breaker 54, and a female duplex electrical outlet 56. Outlet 56 is where the cord 46 from light member 12 will be plugged to connect the light member 12 to power supplied from box 44. The components contained in ballast box 44 are assembled and connected conventionally such that the outlet 56 is provided electrical power by the ballast component 50 when the photoelectric switch 52 is activated by lack of exposure to light, and the ground fault interrupter breaker 54 protects system 10 in the event of a short circuit.

Light member 12 is conveniently made of a length of poly vinyl chloride (PVC) pipe 14 having a bottom end 18 and a top end 20. In top end 20 a porcelain lamp holder 16 is sealingly secured within a matrix 22 of paraffin. Lamp holder 16 is connected to one end of power cord 46, which enters an opening in pipe 14 toward bottom end 18, the connection being enclosed within the paraffin matrix 22. A three inch diameter PVC bushing 24 is secured to top pipe end 20 by an adapter 26, also formed of PVC. A 175-watt mercury vapor lamp 28 is installed into lamp holder 16 and the annular gap between the base of the glass bulb portion of installed lamp 28 and bushing 24 is sealed with a first ring 30 of marine grade silicone glue and a second ring 32 of plastic resin. One or more brackets 34 are secured to pipe 14 at attachment fittings 42 located on the side of pipe 14 between ends 18 and 20, and extend upward, over and across the bulb of lamp 28 to protect lamp 28 and provide a convenient handle for the light member 12. After the lamp holder 16 is secured within the paraffin matrix 22, the interior of the pipe 14 is filled with a weighted material 36 such as ready-mix Portland cement which seals the light member 12 and provides sufficient weight that light member 12 has negative buoyancy sufficient to secure light member 12 to the sea floor when installed. The lamp end of member 12 is more buoyant than the bottom end 18 so that when submerged, light member 12 rests on the sea floor with bottom pipe end 18 down. A PVC end cap 40 seals and encloses pipe bottom end 18. The end of power cord 16 not attached to lamp holder 16 has a male plug (not shown), which plugs into outlet 56 to draw power from ballast component 50. A length of protective rubber hose 38 is secured to the pipe 14 and surrounds so much of power cord 46 as is submerged.

The method of assembling a preferred embodiment of the light member of the present invention includes the following steps: First, lamp bulb 28 is glued into the bushing 24 with marine glue 30. The bulb of lamp 28 is pulled into the bushing 24 by screwing the lamp holder 16 onto the lamp 28, which has been inserted through bushing 24, thereby pulling the lamp 28 against the bushing 24. The glue 30 is allowed to harden and is then reinforced and backed by plastic resin 32, which is poured into the inverted lamp and bushing assembly, around the lamp 28 base and the mouth of lamp holder 16. The bushing 24 and adapter 26 are then glued to each other and to the top end 20 of pipe 14. The bare end of the electric cord 46 is inserted through a hole in pipe 14 and connected to the electrical contacts of lamp holder 16. The connection of cord 46 to lamp holder 16 is covered by a matrix of paraffin wax 22 that has been melted and poured over the base of the lamp holder 16 in the inverted, partially assembled light member 12. The weighted material 36 is then poured as a slurry into the interior of pipe 14 to fill the remaining open volume. Finally end cap 40 is secured over pipe bottom end 18.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and the scope of the present invention. For example, while mercury vapor lamps have characteristics, which are beneficial for use in system 10, it is anticipated that other types of commonly available electrical lamps may be employed for lamp 28. Similarly it is anticipated that other materials may be substituted for the PVC of pipe 14, adapter 24 and end cap 40, such as polyethylene, fiber reinforced resin, or similar materials so long as they have the necessary quality of being durable and impervious to sea water.

What is claimed is:

1. A device for attracting fish comprising an underwater electrically powered light.

2. The device of claim 1 further comprising means for activating the light at dusk and deactivating the light at dawn.

3. The device of claim 2 further comprising a sealed light member comprising an electric lamp installed and sealed in a waterproof socket and weighted material sufficient to cause the light member to have negative buoyancy.

4. The device of claim 3 further comprising a ballast box member and an electrical cord connecting the light member and the ballast box member, and means for connecting the ballast box member to a source of household electrical current.

5. The device of claim 4 wherein the means for activating and deactivating the light member comprises a photoelectric switch.

6. The device of claim 5 further comprising a ground fault circuit interrupter.

7. The device of claim 6 wherein the light member is generally tubular and the weighted material is positioned adjacent to a first light member end and the lamp is positioned adjacent to the other, second end of the light member.

8. The device of claim 7 wherein the light member further comprises a tubular body formed of a material that is impervious to seawater.

9. The device of claim 8 wherein the lamp comprises a bulb and the lamp bulb protrudes from the second end of the tubular body.
